(19) United States
(12) Patent Application Publication
(10) Pub. No.: US 2018/0333985 A1
(43) Pub. Date: Nov. 22, 2018

(54) Wheel Unit for a Vehicle

(71) Applicant: Gustav Magenwirth GmbH & Co. KG, Bad Urach (DE)

(72) Inventor: Michael Ruopp, Berghuelen (DE)

(21) Appl. No.: 15/980,082

(22) Filed: May 15, 2018

(30) Foreign Application Priority Data
May 19, 2017 (DE) 10 2017 110 946.3

(51) Int. Cl. B60B 27/00; B60B 1/00; B62L 1/00; B62L 5/00; B60T 8/32; B62L 5/20

(52) U.S. Cl. CPC B60B 27/0068; B60B 1/003; B60B 27/0052; B62L 1/005; B60T 1/065; B60T 8/3225; B62L 5/20; B62K 2207/00; B62L 5/006

(57) ABSTRACT

In order to improve a wheel unit, in particular for a vehicle, comprising a wheel having a hub and a wheel rim which are connected to one another by spokes and are arranged for rotation about an axis of rotation, it is proposed that the wheel have connected thereto a disc unit arranged coaxially with respect to the axis of rotation, said disc unit carrying a brake ring for a disc brake and a sensor ring for detecting a rotary movement of the wheel unit.

### CROSS-REFERENCE TO RELATED PATENT APPLICATION

This patent application claims the benefit of German application No. 10 2017 110 946.3 filed May 19, 2017, the teachings and disclosure of which are hereby incorporated in their entirety by reference thereto.

### BACKGROUND OF THE INVENTION

The invention relates to a wheel unit for a vehicle, in particular for a two-wheeled vehicle, preferably a bicycle, comprising a wheel having a hub and a wheel rim which are connected to one another by spokes and are arranged for rotation about an axis of rotation.

Wheel units of this type, in particular for bicycles, are known from the prior art, for example wherein two-wheeled vehicles, in particular bicycles, comprise a front wheel unit and a rear wheel unit and wherein the wheel units are connected together by a frame.

In the context of the following description, a bicycle is understood to mean a vehicle which is either driven by a rider's muscle force alone or which can be driven by a rider through his or her muscle power and comprises a supplemental drive, in particular one which has zero exhaust gas emission, for example a zero CO₂ emission, in particular wherein the supplemental drive complements the propulsion from human muscle force and/or replaces this, for example at times when riding along stretches of route that would otherwise require strenuous effort from the rider.

In particular, the supplemental drive comprises an electric drive motor which is preferably supplied with electrical energy from a current storage device or from a fuel cell so that the supplemental drive does not require fossil fuels for example.

Thus, in the sense used hereinafter, the term “bicycle” includes in particular bicycles which are drivable by the rider's muscle power as well as bicycles which, for example, are drivable by the rider's muscle force and are driven by a continuously operating or an activatable supplemental drive, such as e-bikes and pedelecs.

In particular, vehicles of this type, in particular bicycles, attain maximum speeds of at most 100 kilometres per hour, for example at most 80 kilometres per hour, in particular at most 60 kilometres per hour and preferably at most 40 kilometres per hour.

Therefore, a two-wheeled vehicle and, therefore, in particular the wheel unit for the two-wheeled vehicle, in particular the bicycle built in lightweight construction, is designed for such a maximum speed.

Furthermore, in the sense used hereinafter, two-wheeled vehicles, in particular bicycles, are lightweight vehicles weighing for example at most 100 kilograms, in particular at most 80 kilograms, particularly preferably at most 50 kilograms, in particular at most 30 kilograms, and thus the wheel unit of the bicycle is designed for a load created by such maximum weight plus the weight of the rider.

The object of the invention is to improve a generic wheel unit for a vehicle, in particular a two-wheeled vehicle, preferably a bicycle.

### SUMMARY OF THE INVENTION

In accordance with the invention, this object is achieved in a wheel unit of the type described at the outset in that connected to the wheel is a disc unit arranged coaxially with respect to the axis of rotation, said disc unit carrying a brake ring for a disc brake and a sensor ring for detecting a rotary movement of the wheel unit.

The advantage of the solution in accordance with the invention is seen in that by way of the disc unit provided on the wheel unit, it is possible to implement both a disc brake and a capability of detecting the rotary movement of the wheel unit which is in particular suitable for rotational speed detection and, for example, for operating an anti-lock braking system.

It is particularly advantageous for the sensor ring and the brake ring to be arranged relative to one another in the disc unit in such a way that centre planes thereof in which they extend are parallel to each other and in particular in close side-by-side relation to each other.

This means that a very slim and space-conserving construction of the disc unit can thereby be implemented in a direction transverse to the centre planes, this being of great advantage, especially for use in a bicycle.

It is even more advantageous for the sensor ring and the brake ring to be arranged relative to one another in the disc unit such that the centre planes in which they extend are coincident with one another so that a construction of the disc unit is thereby achieved which in its extension in a direction transverse to the centre planes corresponds to the transverse extent of a brake ring for a disc brake and, therefore, provides maximum space conservation.

With regard to the arrangement of the sensor ring, no details have been given in conjunction with the previous description of the solution in accordance with the invention.

It is preferably provided for the sensor ring to lie radially inside the brake ring so that the brake ring can always easily be grasped and braked by way of a brake calliper.

A particularly advantageous solution provides for the disc unit to comprise a sensor disc comprising the sensor ring, said sensor disc being connected to the wheel and carrying the brake ring.

Thus, the advantage of the present solution is seen in that the sensor disc represents a carrier for the brake ring and there is therefore no longer a need for a brake disc as such; rather, all that is needed is the brake ring which is carried by the sensor disc.

This also provides additional degrees of freedom with regard to the choice of materials for the sensor disc and the brake ring because the brake ring can be optimized in terms of surface properties for the braking function, while the material for the sensor disc carrying the brake ring can be selected and optimized uninfluenced thereby.

No details have been provided so far with respect to the connection between the brake ring and the sensor disc.

Thus, an advantageous solution provides for the brake ring to be connected to the sensor disc by way of a form-locking connection.

The form-locking connection may be configured in a wide variety of ways.

By way of example, there may be provided form-locking elements integrally moulded on the sensor disc and the brake ring, which form-locking elements interengage with one another.

Another advantageous solution provides for the form-locking connection to be configured as a riveted connection or a screwed connection.

It is particularly advantageous for the form-locking connection to allow a relative movement of the brake ring with respect to the sensor disc that is parallel to a centre plane of the sensor disc and is limited.

This solution is greatly advantageous in that, for example, a temperature rise in the brake ring due to the braking action and, hence, an expansion of the material can be accommodated at least in part by the allowed limited relative movement of the brake ring with respect to the sensor disc so that this deformation of the brake ring does not affect or does not substantially affect the sensor disc.

No details have been given so far as to the manner of connecting together the brake ring and the sensor disc.

Thus, it is preferably provided for the brake ring to be connected to the sensor disc by way of holding noses which engage in recesses.

To this end, for example, one of the holding noses is arranged on the brake ring and the corresponding recess is arranged on the sensor disc or vice versa.

This solution is relatively easy to implement and assures sufficiently good stability.

In the provision of holding noses and recesses, it is preferably provided for the recesses and the holding noses to serve as form-locking elements effective in a direction of rotation for a rotationally fixed connection between the brake ring and the sensor disc so that the force transfer which occurs from the brake ring to the hub when braking is realized via the recesses and the holding noses.

This is particularly advantageous if the recesses and holding noses extend in the same centre plane.

No details have been provided yet about the arrangement of the holding noses and recesses.

Thus, an advantageous solution provides for the holding noses and the recesses to be arranged such that they lie radially between the sensor disc and the brake ring.

In particular, it is preferably provided for form-locking surfaces connecting the respective recess to the respective holding nose in rotationally fixed relation therewith to lie radially outside of the sensor ring so that the configuration of the sensor ring is unaffected thereby.

Furthermore, it is preferably provided for the form-locking surfaces connecting the recess and the respective holding nose in rotationally fixed relation to lie radially between the sensor ring and the brake ring.

In a further advantageous solution, provision is made for the respective recess and the respective holding nose cooperating therewith to extend into a sensing area of the sensor ring.

In particular, it is provided that the periodic structure of the sensing area is continued in the portion of the holding nose that extends into the sensing area.

No details have been given so far with respect to the connection of the sensor disc to the hub.

In an embodiment, the sensor disc is connected to the wheel rim.

An advantageous solution provides for the sensor disc to be connected to a hub of the wheel.

Thus, an advantageous solution provides for the sensor disc to be connected to the hub in form-locking relation therewith.

Preferably, the sensor disc is held to a support ring mounted on the hub and connected to the hub in rotationally fixed relation by form-locking engagement therewith.

As an alternative to the previously described solution in which a sensor disc carries the brake ring, another solution provides for the disc unit to have a brake disc comprising the brake ring, said brake disc being connected to the wheel, and for the sensor ring to be held to the brake disc.

Thus, in this exemplary embodiment, the sensor ring itself is mounted to the brake disc and is in particular in contact against same.

It is preferably provided for the sensor ring to be connected to the brake disc by way of form-locking elements.

Connection to the wheel can be effected in a variety of ways.

An advantageous solution provides for the brake disc to be connected to the wheel in form-locking relation therewith.

In an embodiment, the brake disc is also connected to the wheel rim.

It is preferably provided for the brake disc to be connected to the hub.

Advantageously, the form-locking elements connecting the sensor ring to the brake disc are arranged radially outside of a connection of the brake disc to the hub so that this connection between the sensor ring and the brake disc need only be dimensioned such that the sensor ring is reliably fixed to the brake disc but not influenced by any mechanical loads on the brake disc.

By way of example, the connection could be made using a screwed or riveted connection between the brake disc and the hub that absorbs the forces acting between the brake disc and the hub.

Another advantageous solution provides for the brake disc to be held to a support ring mounted on the hub and connected to the hub in rotationally fixed relation by form-locking engagement therewith so that the connection between the brake disc and the hub is realized via the support ring.

In conjunction with the previous description of the individual exemplary embodiments, no details have been provided yet in regard to the connection between the hub and the wheel unit.

It is preferably provided for the hub to be arranged on a wheel suspension of the wheel unit for rotation about an axis of rotation.

In order to detect the sensor ring, in particular a sensing area thereof, it is preferably provided for the wheel unit to have associated therewith a sensor for detecting a sensing area of the sensor ring.

The sensor is preferably arranged on the wheel suspension.

Such a sensor allows the rotational movement of the wheel relative to the wheel suspension to be detected for a wide variety of applications.

Moreover, it is preferably provided for the wheel unit to comprise a brake calliper which cooperates with the brake ring when braking.

The brake calliper can be actuated in a number of different ways.

It is particularly advantageous for the brake calliper to represent a slave unit of a braking system, for example of a hydraulic brake system.

In order to arrange the sensor advantageously relative to the brake calliper, it is preferably provided for the sensor to be arranged in connected relation to the brake calliper.

The solution is particularly advantageous if the brake calliper itself is arranged on the wheel suspension.

Furthermore, the invention relates to a vehicle, in particular a bicycle, comprising a front wheel unit and a rear wheel unit which are connected together by a frame.

In accordance with the invention, provision is made for at least one of the wheel units of the vehicle, in particular of the bicycle, to be configured in accordance with the features of any one of the preceding embodiments.

It is particularly advantageous if both the front wheel unit and the rear wheel unit are configured in accordance with the features of any one of the preceding embodiments.

Preferably, the wheel unit is configured such that it comprises a disc brake, in particular a hydraulically actuatable disc brake.

Moreover, it is preferably provided for the vehicle, in particular the bicycle, to comprise an anti-lock braking system which interacts with a sensor unit comprising the sensor ring and the sensor and with the disc brake.

Furthermore, the vehicle, in particular the bicycle, is driven via a muscle-powered drive system which may be assisted by a supplemental drive, wherein the supplemental drive comprises for example an electric drive motor.

Further features and advantages of the solution in accordance with the invention are the subject matter of the following description and the drawings illustrating some exemplary embodiments thereof.

### BRIEF DESCRIPTION OF THE DRAWINGS

FIG. 1 shows a side view of a first exemplary embodiment of a bicycle in accordance with the invention;

FIG. 2 shows a portion of a side view of a first exemplary embodiment of a front wheel unit in accordance with the invention, for use in a bicycle;

FIG. 3 shows a section along line 3-3 in FIG. 2;

FIG. 4 shows a side view of a first exemplary embodiment of a disc unit in accordance with the invention;

FIG. 5 shows a section along line 5-5 in FIG. 4;

FIG. 6 shows an enlarged representation of a detail marked A in FIG. 4;

FIG. 7 shows a partially enlarged sectional view taken along line 7-7 in FIG. 6;

FIG. 8 shows a sectional view, on an enlarged scale, of a detail marked B in FIG. 7;

FIG. 9 shows a side view, similar to FIG. 4, of a second exemplary embodiment of a disc unit in accordance with the invention;

FIG. 10 shows an enlarged view of a detail marked C in FIG. 9;

FIG. 11 shows a section along line 11-11 in FIG. 10;

FIG. 12 shows a side view, similar to FIG. 4, of a third exemplary embodiment of a disc unit in accordance with the invention;

FIG. 13 shows an enlarged view of a detail marked D in FIG. 12;

FIG. 14 shows a side view of the fourth exemplary embodiment of a disc unit in accordance with the invention;

FIG. 15 shows a partially enlarged representation of the detail marked E in FIG. 14;

FIG. 16 shows a section along line 16-16 in FIG. 15;

FIG. 17 shows an enlarged representation of the detail marked F in FIG. 16; and

FIG. 18 shows a side view of a fifth exemplary embodiment of a disc unit in accordance with the invention.

### DETAILED DESCRIPTION OF THE INVENTION

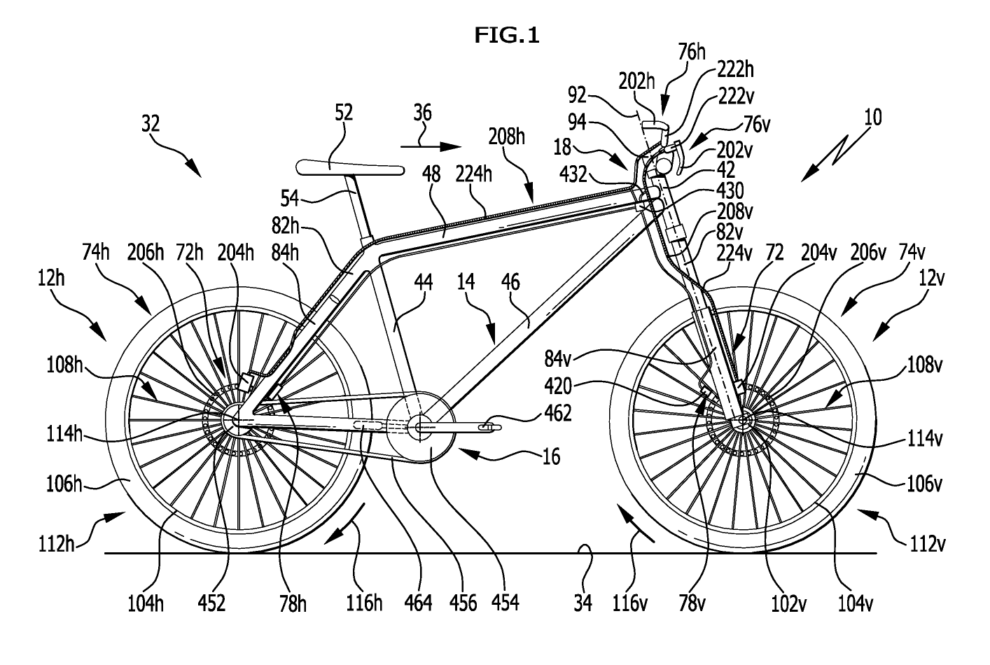

A first exemplary embodiment of a bicycle in accordance with the invention, shown by way of example in FIG. 1 and generally designated therein at 10, comprises a front wheel unit 12v and a rear wheel unit 12h which are connected together by a frame 14, and a bicycle drive system, designated generally at 16, which is driven for example by the muscle force exerted by a rider, and an anti-lock braking system 18.

The bicycle 10 extends substantially in a main plane 32 which in FIG. 1 corresponds substantially to the drawing plane and which, when the bicycle 10 stands on a horizontal standing surface 34 in a ready-to-ride condition as depicted in FIG. 1, is substantially transverse, in particular perpendicular, to the standing surface 34.

The front wheel unit 12v is arranged in a front region of the bicycle 10 and the rear wheel unit 12h is arranged in a rear region of the bicycle 10, relative to a bicycle orientation 36 which corresponds to the direction of travel when the bicycle 10 is riding straight ahead.

The frame 14 comprises a head tube 42 on which the front wheel unit 12v is arranged for rotary movement, and a rear strut 44 on which the rear wheel unit 12h is arranged, wherein the head tube 42 and the rear strut 44 are connected to one another by a first tube 46 and, for example, a further, second tube 48.

Furthermore, the frame 14 has arranged thereon a saddle 52 comprising a saddle tube 54.

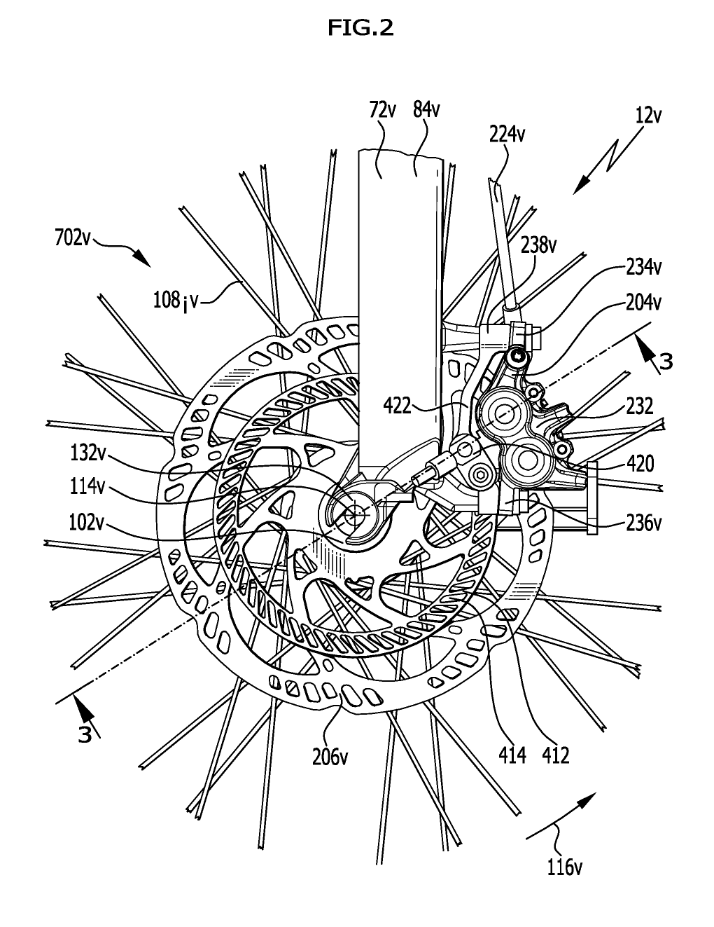

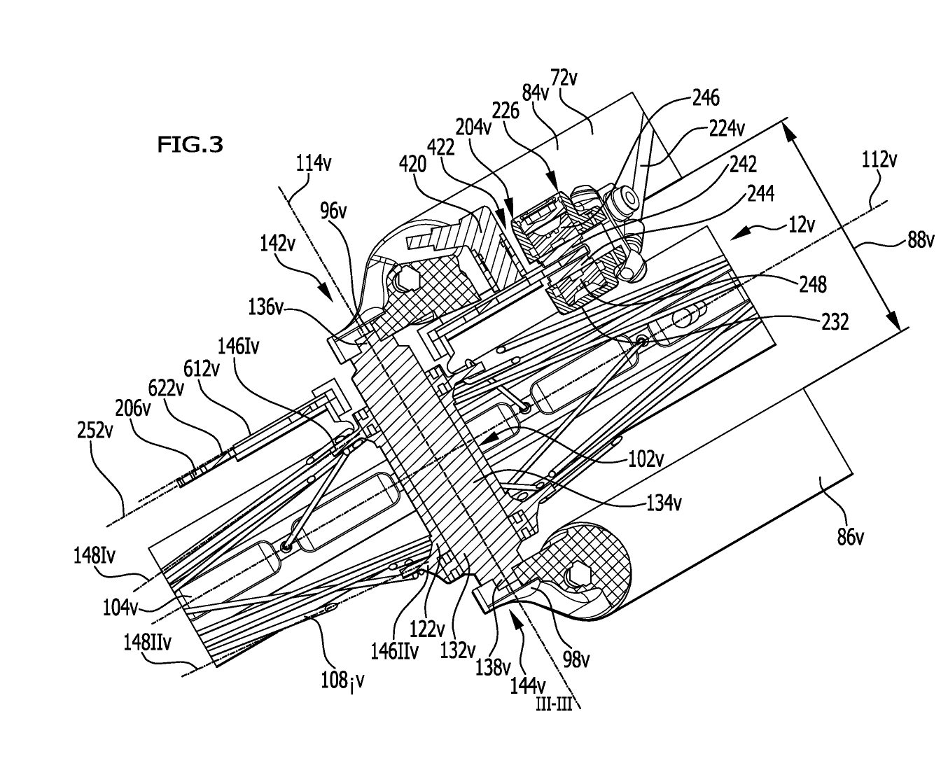

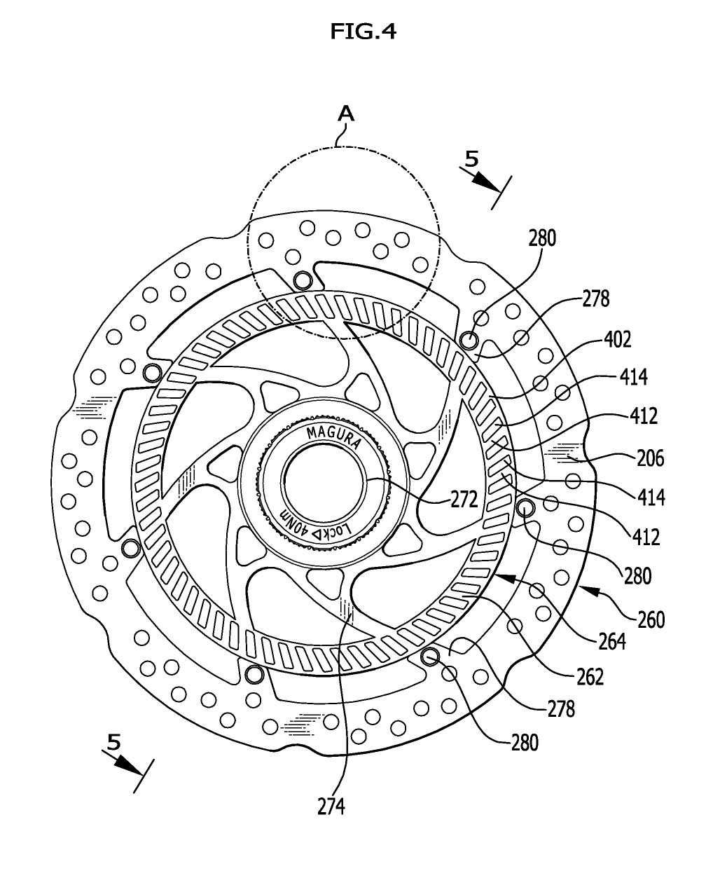

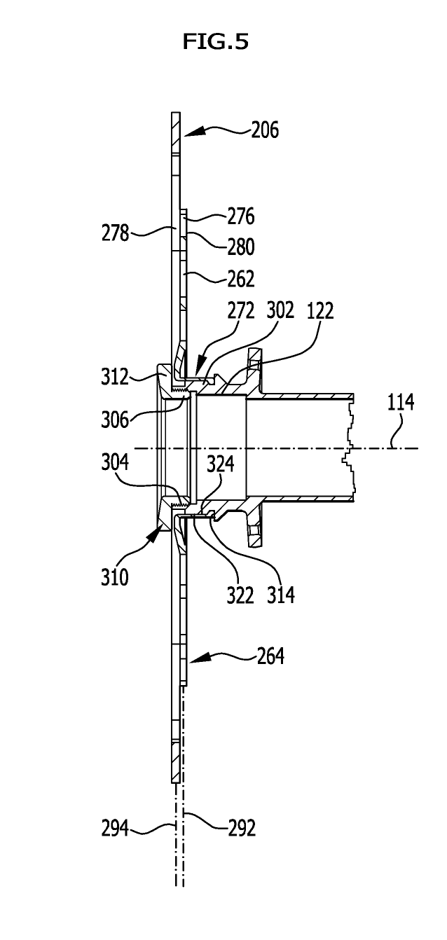

The front wheel unit 12v, which is illustrated in FIGS. 2 and 3, and the rear wheel unit 12h, which is illustrated in FIGS. 4 and 5, are of similar construction and will be described jointly hereinafter insofar as they are constructed analogously, wherein the indicia v and h are omitted where not necessary.

The wheel unit 12 comprises a wheel suspension 72, a wheel 74 which is arranged for rotation on the wheel suspension 72, a brake device 76 configured as a disc brake by way of which a braking action can be applied to the wheel 74 so that, under the braking action of the brake device 76, the rotational speed of the wheel 74 is reduced, and a sensor unit 78 with which the rotational speed of the wheel 74 can be determined.

The wheel suspension 72 comprises a shaft 82, a first fork leg 84 and a second fork leg 86, wherein the fork legs 84 and 86 are connected to the shaft 82.

The first fork leg 84 and the second fork leg 86 extend substantially parallel to one another and are spaced apart from one another by a distance 88 so that the wheel 74 is positioned between the first fork leg 84 and the second fork leg 86.

In particular, the shaft 82v of the front wheel unit 12v is supported on the head tube 42 for rotation about a steering axis 92 so that the front wheel unit 12v can be steered by way of a handlebar 94.

The shaft 82h of the rear wheel unit 12h is for example arranged on the frame 14, in particular on the rear strut 44.

Provided on the wheel suspension 72 are a first dropout 96 which is for example arranged on the first fork leg 84 and a second dropout 98 which is for example arranged on the second fork leg 86, these being for the purpose of fastening the wheel 74.

The wheel 74 comprises a hub 102, a wheel rim 104 on which an air-filled tyre 106 is fitted and a plurality of spokes 108, of which only some spokes 108, are identified by way of example in the figures, wherein the spokes 108 connect the wheel rim 104 to the hub 102.

The wheel rim 104 extends substantially along a circle which lies in a wheel plane 112 and through the centre of which extends a geometric axis of rotation 114, wherein the axis of rotation 114 runs perpendicularly to the wheel plane 112 and wherein the wheel plane 112, in a straight-ahead travel condition of the bicycle 10 illustrated in FIG. 1, coincides with the main plane 32, but wherein the front wheel plane 112v can also extend transversely with respect to the main plane 32 since the front wheel 14v is fastened to the front wheel suspension 72v which is rotatable about the steering axis 92.

The wheel 74 is rotatable in a direction of revolution 116 and is arranged for rotation about the axis of rotation 114.

The direction of rotation 116 runs substantially in the wheel plane 112 and is always oriented perpendicularly to a radial direction of the axis of rotation 114.

The hub 102 is oriented substantially perpendicularly to the wheel plane 112 and along the axis of rotation 114, as is illustrated in FIGS. 2 to 7, and therefore the hub 102 is arranged in the wheel plane 112 in centred relation to the wheel rim 104, as is illustrated in FIG. 1.

The hub 102 comprises a hub housing 122 which is supported for rotation about the axis of rotation 114 on a wheel axle 132 which is oriented coaxially with the axis of rotation 114. An inner region 134 of the wheel axle 132 which lies between a first end region 136 and a second end region 138 of the wheel axle 132 rotatably receives the hub housing 122, and the first end region 136 and the second end region 138 of the wheel axle 132 protrude from the hub housing 122 from opposing front sides 142 and 144 thereof.

The wheel 74 is supported on the wheel suspension 72 by way of the wheel axle 132 which is fixedly connected to the wheel suspension 72, in particular wherein the first end region 136 of the wheel axle 132 is connected to the first dropout 96 and the second end region 138 of the wheel axle 132 is connected to the second dropout 98.

The hub housing 122 comprises a first annular collar 1461 and a second annular collar 14611 which are arranged in offset relation to one another in a direction parallel to the axis of rotation 114 and are located on different sides of the wheel plane 112 and are each placed at an equal distance from the wheel plane 112 so that the first annular collar 1461 is positioned between the wheel plane 112 and the front side 142 and the second annular collar 14611 is positioned between the wheel plane 112 and the second front side 144. The annular collar 1461 and the annular collar 14611 are provided for the purpose of fastening the spokes 108.

Of the spokes 108, spokes 1081 are arranged on the first annular collar 1461 and spokes 10811 are arranged on the second annular collar 14611, wherein the number of spokes 1081 and the number of spokes 10811 in each case corresponds to half the total number of spokes 108.

Only some spokes 108 are identified by way of example in the figures.

Insofar as the spokes 1081 and the first annular collar 1461 are configured and arranged analogously to the spokes 10811 and the second annular collar 14611, these will be described jointly hereinafter and the indicia I and II will be omitted where possible.

The spokes 108 extend from the respective annular collar 146 to which they are fastened all the way to the wheel rim 104 to which they are also fastened so that the wheel rim 104 together with the hub housing 122 is rotatable about the axis of rotation 114 with respect to the wheel axle 132.

The spokes 108 extend substantially in a spoke surface 148, wherein the spoke surface 148, in a region of the axis of rotation 114, is spaced apart from the wheel plane 112 by a maximum distance, in particular by a distance by which the annular collar 146 is also spaced from the wheel plane 112 so that the spoke surface 148 extends starting from the annular collar 146 in the radial direction relative to the axis of rotation 114, towards the wheel plane 112, and meets the wheel plane 112 in the area of the wheel rim 104. Thus, the spoke surface 148 is rotationally symmetric with respect to the axis of rotation 114 and is of conical configuration.

The first spoke surface 1481 and the second spoke surface 14811 extend substantially mirror-symmetrically with respect to the wheel plane 112 so that the central regions of the cone-like spoke surfaces 1481 and 14811 are spaced along the axis of rotation 114 and the spoke surfaces 1481 and 14811 converge towards one another starting from the axis of rotation 114.

The brake device 76 comprises an actuation unit 202, a brake calliper 204 which is in particular arranged on the wheel suspension 72, and a brake ring 206 which is connected to the hub 102, in particular to the hub housing 122, in rotationally fixed relation therewith.

The actuation unit 202, for example a master cylinder 222 having a lever, and the brake calliper 204 are operatively connected for pressure communication via a hydraulic system 208 so that actuating the actuation unit 202 actuates the brake calliper 204, whereby the brake calliper 204 brakingly cooperates with the brake ring 206 and, as a result of this, a rotational movement of the brake ring 206 is braked and, since the brake ring 206 is arranged on the wheel 74, a rotational speed of a rotational movement of the wheel 74 is also reduced.

The hydraulic system 208 comprises a master cylinder 222 which is connected via a pressure conduit 224 to a slave cylinder unit 226 connected to the brake calliper 204.

The brake calliper 204 comprises a brake calliper housing 232 which is mounted by way of a first mount 234 and a second mount 236 to the wheel suspension 72, in particular to one of the fork legs 84, 86, using, for example, a brake calliper holder 238.

The brake calliper 204, which is shown to an enlarged scale in FIG. 3, additionally comprises a first brake pad 242 and a second brake pad 244 which are movably arranged on the brake calliper housing 232, wherein the brake pads 242 and 244 are arranged in spaced relation to one another so that the brake ring 206 can be positioned between the brake pads 242 and 244.

The first brake pad 242 is acted upon by a first piston 246 of the slave cylinder unit 226, and the second brake pad 244 is acted upon by a second piston 248 of the slave cylinder unit 226, wherein the first piston 246 and the second piston 248 are connected to the hydraulic system 208, in particular via the pressure conduit 224.

As shown in FIGS. 4 and 5, the brake ring 206 is part of a disc unit 260 which comprises, apart from the brake ring 206, a sensor ring 262 which is located radially inside with respect to the brake ring 206.

In particular, such a sensor ring 262 comprises a sensing area 266 having a structure 268 which revolves about the axis of rotation 114 in a direction of revolution and varies periodically in said direction.

In the first exemplary embodiment, the sensor ring 262 is part of a sensor disc generally designated at 264 which—as shown for example in FIG. 5—comprises a support ring 272 which is connected to the hub housing 122 in a form-locking manner and from which support arms 274 extend all the way to the sensor ring 262 and transition into the sensor ring 262 in one-piece relationship thereto.

Furthermore, the sensor disc 264 comprises holding arms 276 extending on a side of the sensor ring 262 opposite the support arms 274, preferably in continuation of the support arms 274, which holding arms 276 are arranged in overlapping relationship to holding noses 278 of the brake ring 206 and are connected to the holding noses 278 by way of a riveted connection 280.

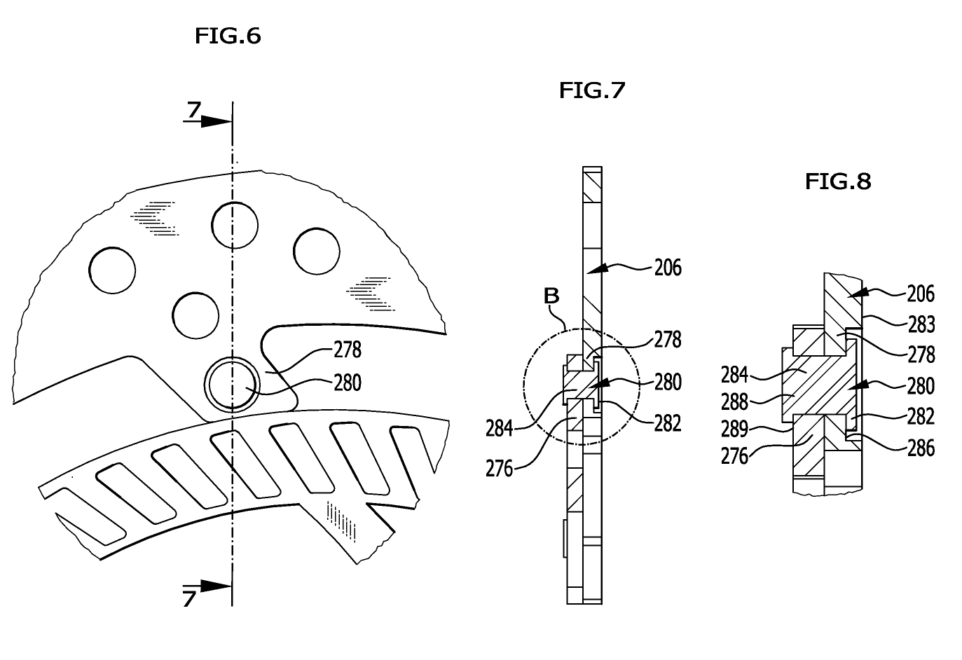

As shown in FIGS. 6, 7 and 8, the riveted connection 280 is configured in such a manner that a rivet head 282 of a rivet body 284 is located in a recess 286 of the holding nose 278 and, in particular, does not project beyond a surface 283 of the holding nose 278 facing away from the holding arm 276, whereas a rivet head 288 which is located opposite the rivet head 282 and is supported on the holding arm 276 projects beyond and in particular engages over a surface 289 of the holding arm 276 located opposite the holding nose 278.

Thus, in the first exemplary embodiment of the disc unit 260 in accordance with the invention, the brake ring 206 is held by way of the sensor disc 264 and is, via the sensor disc 264, connected to the hub housing 122 in rotationally fixed relationship therewith.

As shown in FIG. 5 in particular, a centre plane 292 of the sensor disc 264 which extends perpendicularly to the axis of rotation 114 is oriented parallel to a centre plane 294 of the brake ring 206 which likewise extends perpendicularly to the axis of rotation 114.

Preferably, in the first exemplary embodiment, the support ring 272 sits on a cylindrical support projection 302 of the hub housing 122 arranged on an end side of the hub housing 122 (FIG. 5), said support projection 302 being provided, on an inner side thereof facing towards the axis of rotation 114, with a thread 304 in which engages a threaded section 306 of a fixing ring 310 which, via a pressure flange 312 arranged radially outside the threaded section 306, acts on the support ring 272 in such a manner that the latter is held in contact against a support shoulder 314 formed by the hub housing 122.

Preferably, the support projection 302 has a radially outer teething 322 in which engages an inner teething 324 of the support ring 272, thereby providing a rotationally fixed connection of the latter to the hub housing 122.

Furthermore, the precise alignment of the support ring 272 and hence of the sensor disc 264 relative to the axis of rotation 114 is realized by the support ring 272 being fixed in place between the support shoulder 314 and the pressure flange 312, these providing for alignment of the support ring 272 in such a manner that the sensor disc 264 which is in particular connected to the support ring 272 in one piece has its centre plane 292 extending perpendicularly to the axis of rotation 114.

Because of this, the brake ring 206 which is connected to the sensor disc 264 by way of the riveted connection 280 necessarily is aligned with its centre plane 294 in such a way that the centre plane 294 extends perpendicularly to the axis of rotation 114.

The advantage of the solution in accordance with the invention is seen in that it provides a simple way for the sensor disc 264 together with the support ring 272 to be manufactured, in particular as a one-piece part, for example by a forming process, and to be optimized in respect of stability and in that by the brake ring 206 forming a separately manufacturable part, the material of the brake ring 206 can be chosen independently of the material of the sensor disc 264, wherein the riveted connection 280 represents a simple connection which influences neither the material, in particular the structure, of the brake ring 206 nor the material, in particular the structure, of the sensor disc 264.

It is thereby possible for the brake ring 206 to be manufactured in a manner conforming to the high material requirements imposed on a brake ring, while on the other hand, the sensor disc 264 together with the support ring 272 can be manufactured as a part, in particular as a one-piece part, whose material can be selected independently of the material that is demanded by the brake ring in order to assure the required surface properties of the brake ring 206 for the braking effect.

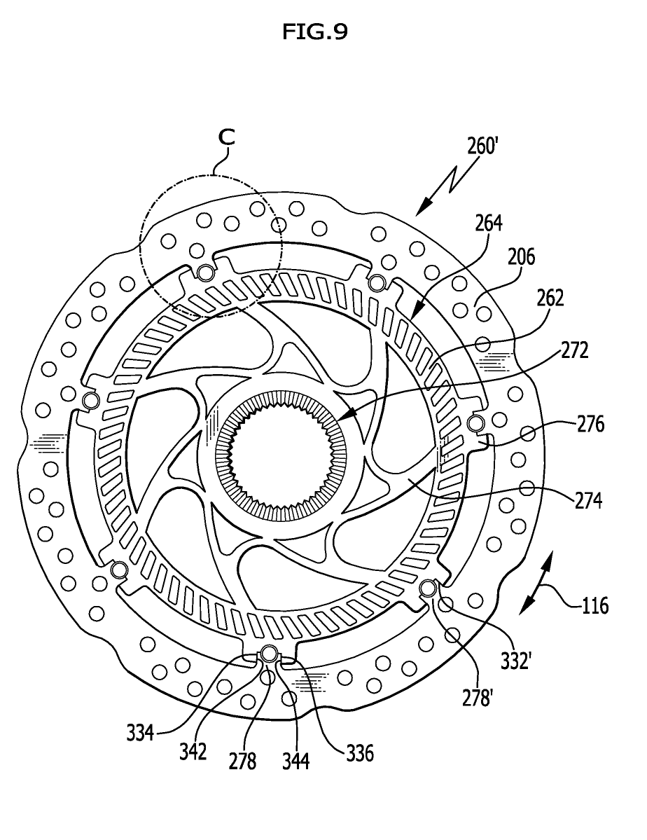

In a second exemplary embodiment of a disc unit 260′ in accordance with the invention, illustrated in FIG. 9, the same reference numerals are used to denote elements that are identical to those described in relation to the first exemplary embodiment so that reference may be made in full to what has been described for the first exemplary embodiment.

In contrast to the first exemplary embodiment, the holding arms 276 which are arranged on the sensor disc 264 and extend radially beyond the sensor ring 262 are provided with recesses 332 which are open towards the brake ring 206 and in which the holding noses 278′ of the brake ring 206 engage, namely in such a way that the holding noses 278′ are, with their side faces 334, 336 opposite to one another in the direction of rotation 116, located between side faces 342 and 344 of the recesses 332 facing towards one another, and therefore a form-locking rotary drive effect between the sensor disc 264 and the brake ring 206 is realized already via the interaction of the side faces 342 and 344 of the recesses 332 and the side faces 334 and 336 of the holding noses 278′ in contact thereagainst.

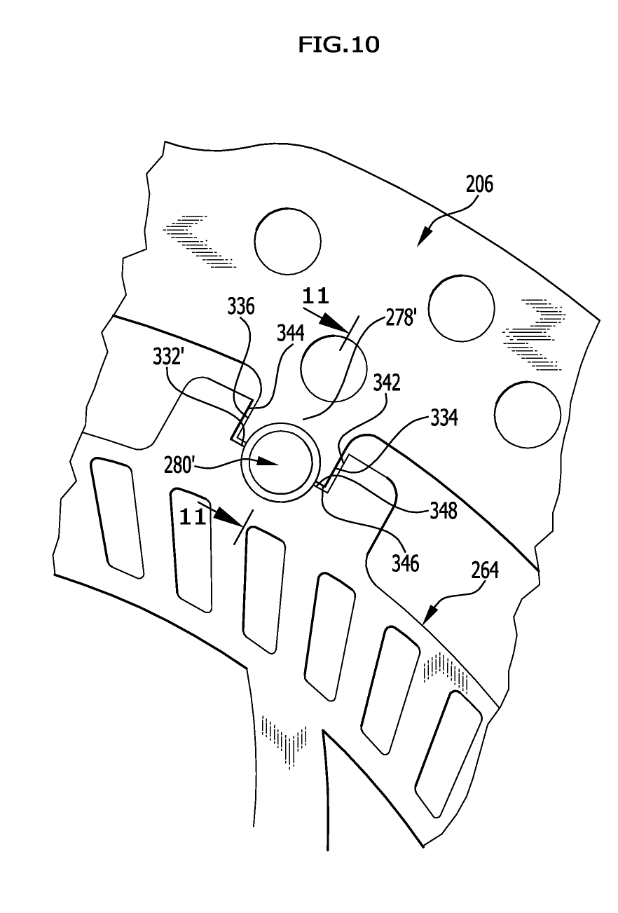

As can be further seen from FIG. 10, the respective holding nose 278′ does not engage into the recess 332 in a radial direction far enough that its radially inner end faces 346 are in contact against the radially outer base faces 348 of the recess 332, but instead some small radial play remains between the sensor disc 264 and the brake ring 206.

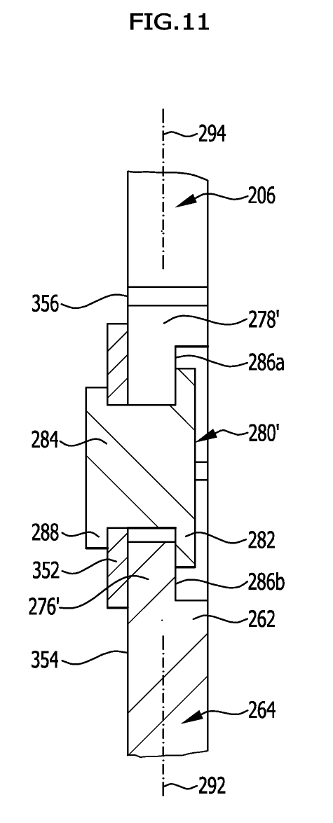

Furthermore, in the second exemplary embodiment, as shown in FIG. 11, the centre plane 292 of the sensor disc 264 and the centre plane 294 of the brake ring 206 coincide with one another so that the centre plane 294 of the brake ring 206 is aligned in line with the centre plane 292 of the sensor ring 262 and the sensor disc 264 and, therefore, the side faces 334 and 336 of the holding noses 278 interact with the side faces 342 and 344 of the respective recess 332.

Such an alignment of the brake ring 206 relative to the sensor disc 264 and the sensor ring 262 is realized, as shown in FIG. 11, through a riveted connection 280′ in which the rivet head 282 is in each case located in half-sided recesses 286a of the respective holding nose 278′ and recesses 286b of the respective holding arm 276, whereas the rivet head 288 of the rivet body 284 acts upon a disc 352 which in each case rests on surfaces 354 of the respective holding arm 276 and on surfaces 356 of the respective holding nose 278′ pointing in the same direction so that the riveted connection 280′ as a whole leads to an alignment of the brake ring 206 relative to the sensor disc 264, in which alignment the centre planes 292 and 294 of same are coincident, but movement parallel to these centre planes 292 and 294 is allowed within the limits of the amount of play between the end faces 346 of the holding noses 278 and the base faces 348 of the recesses 332.

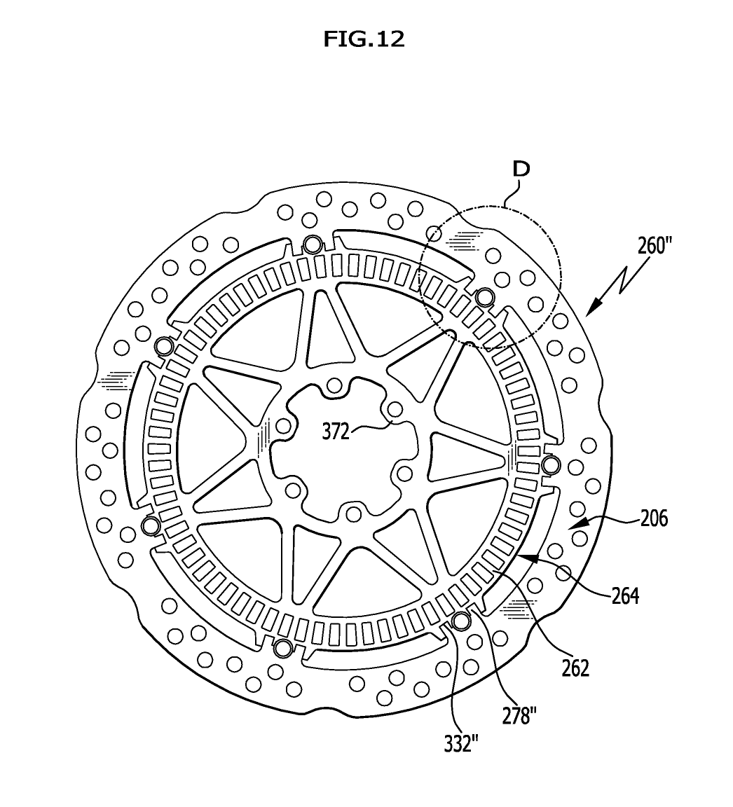

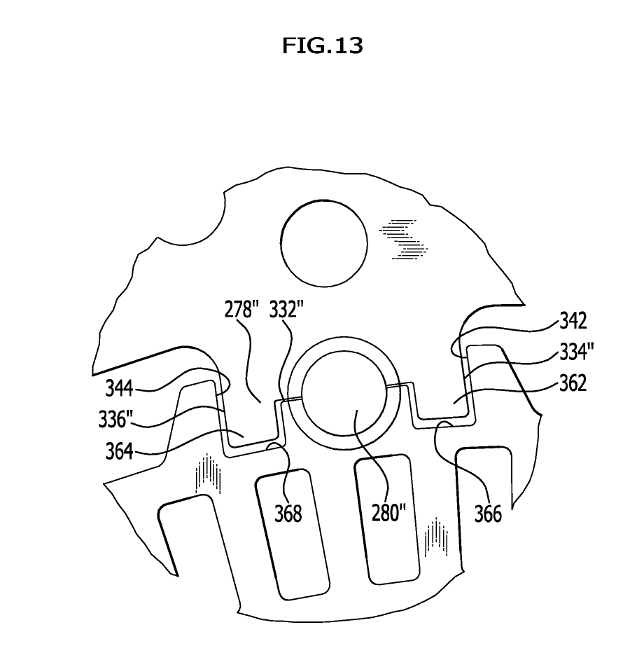

In a third exemplary embodiment of a disc unit 260″ in accordance with the invention, shown in FIGS. 12 and 13, the same reference numerals are used to denote elements that are identical to those described in relation to the preceding exemplary embodiments so that reference may be made in full to what has been described for these exemplary embodiments.

In contrast to the preceding exemplary embodiments and in contrast to the second exemplary embodiment in particular, each of the holding noses 278″ comprises two radially inner and radially inwardly pointing claws 362 and 364 which engage in corresponding cutouts 366 and 368 of the recess 332″ in order to be able to realize a larger radial extension of the side faces 334″ and 336″ and a correspondingly larger extension of the side faces 342 and 344 of the recess 332″.

Furthermore, the riveted connection 280″ is configured identically to the riveted connection 280′ of the second exemplary embodiment so that in particular the centre plane 294 of the brake ring 206 and the centre plane 292 of the sensor disc 264 coincide with one another in a manner identical to what has been described in the context of the second exemplary embodiment.

In contrast to the first and second exemplary embodiments, however, the third exemplary embodiment, shown in FIG. 12 in particular, is not provided with a support ring 272 but only with a support flange 372 which allows, for example, effecting screwed connections or riveted connections to a mounting flange of the hub housing 122 which will be described hereinafter.

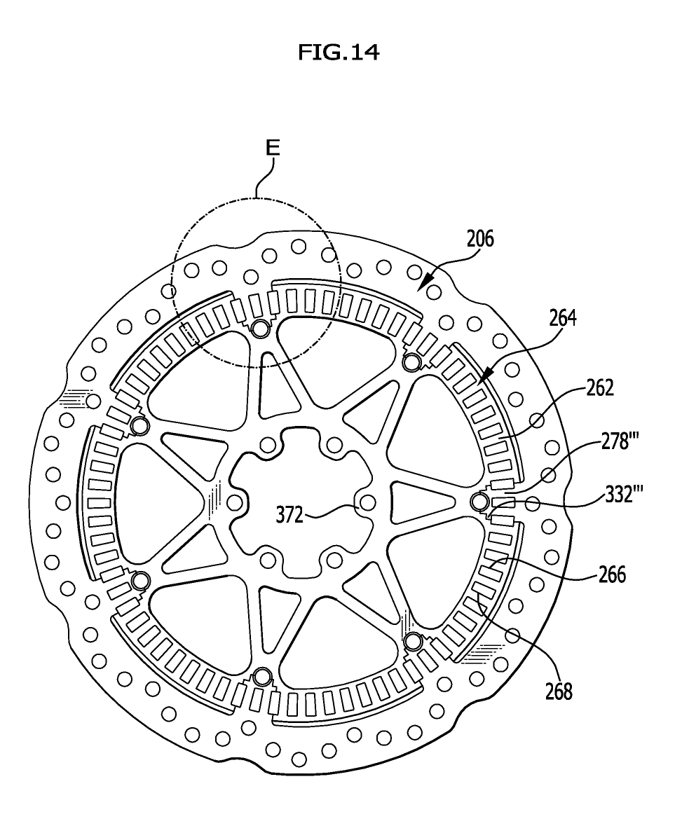

In a fourth exemplary embodiment, represented in FIGS. 14 to 17, the same reference numerals are used to denote elements that are identical to those described in relation to the preceding exemplary embodiments so that reference may be made in full to what has been described for the preceding exemplary embodiments.

In contrast to the second and third exemplary embodiments, the holding noses 278″ extend in a radial direction far enough into the sensor disc 264 that the respective recesses 332″ for receiving the holding noses 278″ also pass through the sensor ring 262.

In particular, the holding noses 278′ extend through the sensing area 266, wherein the periodically varying structure 268 is also continued uninterruptedly in the area of the holding noses 278′.

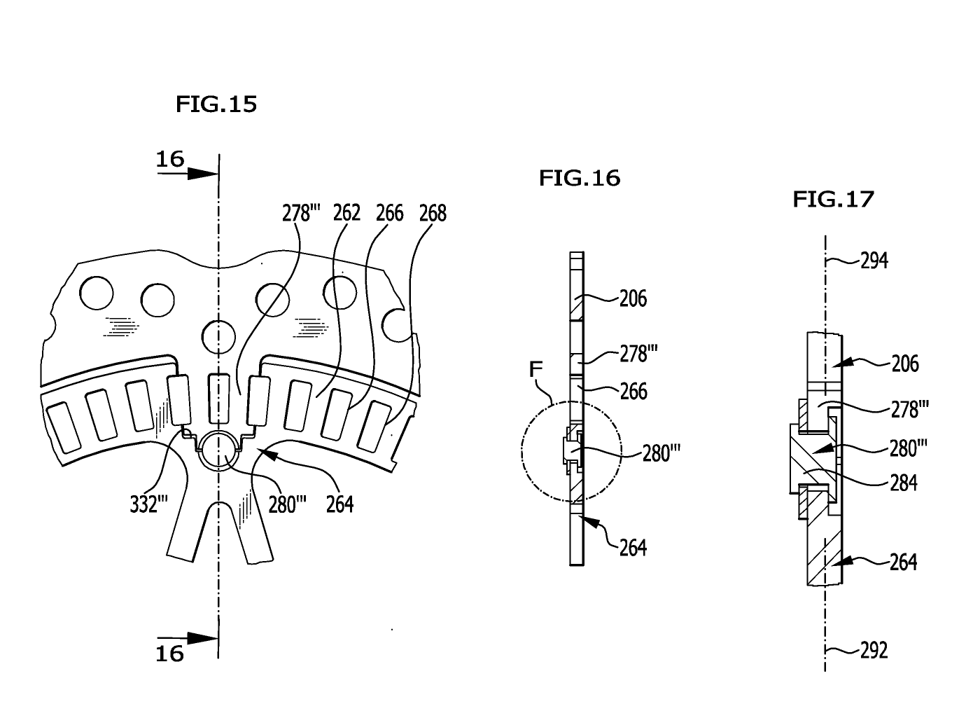

In this case as well, as shown in FIGS. 15 to 17, the holding noses 278″ are arranged relative to the recesses 332″ such that the centre plane 292 of the sensor disc 264 and the centre plane 294 of the brake ring 206 coincide with one another, and that, by way of the riveted connection 280′″, the brake ring 206 is held with its centre plane 294 in the alignment position described in these exemplary embodiments, but also that, as with the second and third exemplary embodiment, the brake ring 206 in its relation to the sensor disc 264 is arranged and guided in floating relationship to the sensor disc 264 because of the radial play therebetween, namely by way of the riveted connection 280″ which is configured identically to that of the second and third exemplary embodiments.

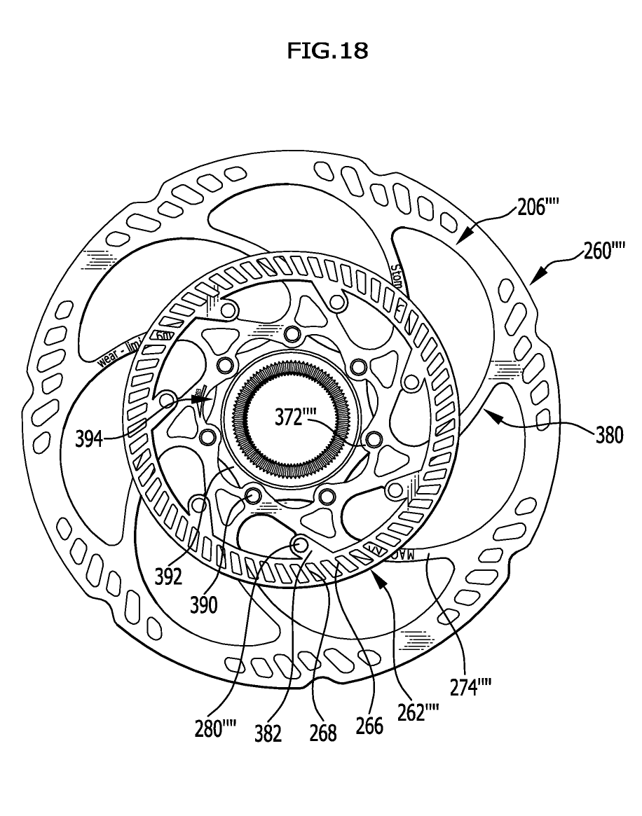

In a fifth exemplary embodiment, represented in FIG. 18, the same reference numerals are used to denote elements that are identical to those described in relation to the preceding exemplary embodiments so that reference may be made in full to what has been described for the preceding exemplary embodiments.

In contrast to the preceding exemplary embodiments, the brake ring 206″″ in the fifth exemplary embodiment is part of a brake disc, generally designed at 380, which in the present case is provided with a support flange 372″″ which has support arms 274″″ extending therefrom to the brake ring 206″″.

In contrast to the preceding exemplary embodiments, in the present exemplary embodiment the sensor ring 262″″ including the sensing area 266 and the periodic structure 268 is not part of a sensor disc but is provided with holding noses 382 which are connected to the brake disc 380 via riveted connections 280″″ and are thus held by the brake disc 380.

However, the riveted connections 280″″ differ from riveted connections 390 which connect the support flange 372″″ to a mounting flange 392 which is part of a support ring 394 that can be fixed to the hub housing 122 in a manner identical to that described for the support ring 272 in the first and second exemplary embodiments.

Preferably, the riveted connections 280″″ are located radially outside of the riveted connections 390 so that this opens up the possibility of having the riveted connections 390 designed with regard to the forces required when braking, which forces are effective between the hub housing 122 and the brake ring 206″″, whereas the riveted connections 280″″ need only be designed for the purpose of realizing reliable positioning of the sensor ring 262 relative to the hub housing 122 and co-rotation of the sensor ring 262 with the hub housing 122.

In particular, in all of the above-described exemplary embodiments, the periodically varying structure 268 is configured as a toothed structure, wherein the toothed structure revolves in a direction of revolution about the axis of rotation 114, along the sensing area 266.

The toothed structure is formed by teeth 402 which also lie substantially in the centre plane 292 of sensor ring 262 and, in particular, extend at an inclined angle relative to a radial direction with respect to the axis of rotation 114, in particular wherein the orientation of the teeth 402 is approximately adapted to the orientation of the support arms 274 of the sensor disc 264 or the brake disc 380 relative to the radial direction with respect to the axis of rotation 114.

Preferably, the teeth 402 are configured with an elongated shape along a direction of extent, wherein the direction of extent is also oriented at an inclined angle relative to the radial direction with respect to the axis of rotation 114.

In particular, the teeth 402 are formed by material bridges 412, wherein a through-opening 414 is arranged between each of the material bridges 412.

The material bridges 412 and the through-openings 414 are arranged in a periodically alternating manner along the direction of revolution about the axis of rotation 114 and thus form a rotationally symmetrical arrangement with respect to the axis of rotation 114, wherein all material bridges 412 are equal in extent in the direction of revolution and all through-openings 414, whose number corresponds to that of the material bridges 412, are equal in configuration to each other in the direction of revolution.

Preferably, the material bridges 412 and the through-openings 414 extend along a direction of extent that is at an inclined angle relative to a radial direction with respect to the axis of rotation 114.

The material bridges 412 are of a magnetic field influencing configuration, such as made of a material that has a strong influence on the magnetic field.

Thus, the periodically varying sequence of material bridges 412, which exert an influence on the magnetic field, and through-openings 414, which influence the magnetic field only weakly, if at all, forms a structure that periodically exerts influence of varying degree on a magnetic field, wherein the degree to which the magnetic field is influenced changes abruptly when transitioning from one of the material bridges 412 to one of the through-openings 414.

The periodically varying structure 268 is detected by a sensor 420.

The sensor 420 is, for example, a magnetic field detecting sensor, wherein the magnetic field detecting sensor 420 itself generates a magnetic field and detects the influence on this magnetic field.

To this end, the sensor 420 comprises for example a Hall sensor which detects the influence of the alternating material bridges 412 and through-openings 414 on the basis of their differing influence on the magnetic field and thus generates Hall voltages of different magnitudes.

Preferably, the sensor 420 is held in place by way of a sensor holder 422 which is connected to the wheel unit 12, for example to the brake calliper holder 238.

The sensor 420 is associated with the sensing area 266 so that a sensed portion of the sensing area 266 is spaced no farther away from the sensor 420 than the range of said sensor 420 and, therefore, said portion of the sensing area 266 is reliably detected by the sensor 420.

The anti-lock braking system 18 comprises a control unit 430 which is operatively connected to the sensor units 78v and 78h of the front and rear wheel units 12v and 12h for signal communication therewith, and a pressure regulation unit 432 which is connected to the hydraulic system 208v of the front wheel unit 12v and, in a variant, is connected in analogous manner to the hydraulic system 208h of the rear wheel unit 12h, for regulating the pressure in the hydraulic system 208, wherein the control unit 430 controls the pressure regulation unit 432 depending on the measured rotational speeds of the front wheel 74v and the rear wheel 74h which are determined by the sensor units 78 and transmitted to the control unit 430.

The control unit 430 of the anti-lock braking system 18 determines, from the rotational speeds of the wheels 74v and 74h transmitted from the sensor units 78v and 78h, the difference between the two rotational speeds of the wheels 74 and from this determines, for example in the case of an excessively large deviation of the two rotational speeds relative to one another, whether one of the wheels 74 has locked, i.e. whether the rotational speed thereof is significantly slower compared with the rotational speed of the other wheel 74, wherein the locking is caused by a heavy actuation of the actuation unit 202 of the brake device 76 and a resultant heavy braking effect generated by the brake calliper 204 on the brake ring 206, in particular on the brake disk 380, and therefore on the wheel 74.

If the control unit 430 determines that the wheel 74 has locked, it activates the pressure regulation unit 432, whereupon the pressure regulation unit 432 causes the pressure in the hydraulic system 208 of the brake device 76 to be reduced, such as by the pressure regulation unit 432 permitting some of the hydraulic fluid from the hydraulic system 208 to bypass into an intermediate reservoir.

As a result of the pressure reduction in the hydraulic system 208, induced by the pressure regulation unit 432, the pistons 246 and 248 apply less force to the brake pads 242 and 244 and, therefore, the brake pads 242 and 244 press with less force against the brake ring 206, in particular against the brake disk 380, so that friction thereagainst decreases and the lock of the wheel 74 is released and the wheel 74 turns again.

The bicycle drive system 16 comprises for example a sprocket wheel 452 which is arranged on the hub housing 122h of the rear wheel unit 12h, a chainring 454 and a chain 456 which is tensioned between the sprocket wheel 452 and the chainring 454 so that a rotational movement is transmitted by the chain 456 from the chainring 454 to the sprocket wheel 452, and pedals 462 and 464, as is illustrated in FIG. 1.

In a further exemplary embodiment, the bicycle drive system 16 additionally comprises an electric motor.

1. Wheel unit, in particular for a bicycle, comprising a wheel having a hub and a wheel rim which are connected to one another by spokes and are arranged for rotation about an axis of rotation,
connected to the wheel is a disc unit arranged coaxially with respect to the axis of rotation, said disc unit carrying a brake ring for a disc brake and a sensor ring for detecting a rotary movement of the wheel unit.

2. Wheel unit in accordance with claim 1, wherein the sensor ring and the brake ring are arranged relative to one another in the disc unit in such a way that centre planes thereof in which they extend are parallel to each other.

3. Wheel unit in accordance with claim 1, wherein the sensor ring and the brake ring are arranged relative to one another in the disc unit in such a way that the centre planes in which they extend are coincident with one another.

4. Wheel unit in accordance with claim 1, wherein the sensor ring lies radially inside the brake ring.

5. Wheel unit in accordance with claim 1, wherein the disc unit comprises a sensor disc comprising the sensor ring, said sensor disc being connected to the wheel and carrying the brake ring.

6. Wheel unit in accordance with claim 5, wherein the brake ring is connected to the sensor disc by way of a form-locking connection.

7. Wheel unit in accordance with claim 5, wherein the form-locking connection allows a relative movement of the brake ring with respect to the sensor disc that is parallel to a centre plane of the sensor disc and is limited.

8. Wheel unit in accordance with claim 5, wherein the brake ring is connected to the sensor disc by way of holding noses which engage in recesses.

9. Wheel unit in accordance with claim 8, wherein the recesses and the holding noses serve as form-locking elements effective in a direction of rotation for a rotationally fixed connection between the brake ring and the sensor disc.

10. Wheel unit in accordance with claim 8, wherein the holding noses and the recesses are arranged such that they lie radially between the sensor disc and the brake ring.

11. Wheel unit in accordance with claim 10, wherein form-locking surfaces connecting the respective recess to the respective holding nose in rotationally fixed relation therewith lie radially outside of the sensor ring.

12. Wheel unit in accordance with claim 11, wherein the form-locking surfaces connecting the recess and the respective holding nose in rotationally fixed relation lie radially between the sensor ring and the brake ring.

13. Wheel unit in accordance with claim 8, wherein the respective recess and the respective holding nose cooperating therewith extend into a sensing area of the sensor ring.

14. Wheel unit in accordance with claim 13, wherein a periodic structure of the sensing area is continued in the portion of the holding nose that extends into the sensing area.

15. Wheel unit in accordance with claim 5, wherein the sensor disc is connected to a hub of the wheel.

16. Wheel unit in accordance with claim 15, wherein the sensor disc is connected to the hub in form-locking relation therewith.

17. Wheel unit in accordance with claim 16, wherein the sensor disc is held to a support ring mounted on the hub and connected to the hub in rotationally fixed relation by form-locking engagement therewith.

18. Wheel unit in accordance with claim 1, wherein the disc unit has a brake disc comprising the brake ring, said brake disc being connected to the wheel, and wherein the sensor ring is held to the brake disc.

19. Wheel unit in accordance with claim 18, wherein the sensor ring is in contact against the brake disc.

20. Wheel unit in accordance with claim 18, wherein the sensor ring is connected to the brake disc by way of form-locking elements.

21. Wheel unit in accordance with claim 18, wherein the brake disc is connected to the wheel in form-locking relation therewith.

22. Wheel unit in accordance with claim 18, wherein the brake disc is connected to a hub of the wheel.

23. Wheel unit in accordance with claim 22, wherein the form-locking elements connecting the sensor ring to the brake disc are arranged radially outside of a connection of the brake disc to a hub of the wheel.

24. Wheel unit in accordance with claim 22, wherein the brake disc is held to a support ring mounted on the hub and connected to the hub in rotationally fixed relation by form-locking engagement therewith.

25. Wheel unit in accordance with claim 1, wherein the hub of the wheel is arranged on a wheel suspension of the wheel unit for rotation about an axis of rotation.

26. Wheel unit in accordance with claim 1, wherein the wheel unit has associated therewith a sensor for detecting a sensing area of the sensor ring.

27. Wheel unit in accordance with claim 26, wherein the sensor is arranged on the wheel suspension.

28. Wheel unit in accordance with claim 1, wherein the wheel unit comprises a brake calliper which brakingly cooperates with the brake ring.

29. Wheel unit in accordance with 26, wherein the sensor is arranged in connected relation to the brake calliper.

30. Wheel unit in accordance with claim 28, wherein the brake calliper itself is arranged on the wheel suspension.

31. Vehicle, in particular bicycle, comprising a front wheel unit and a rear wheel unit which are connected together by a frame, wherein at least one of the wheel units of the bicycle is configured in accordance with claim 1.

32. Vehicle in accordance with claim 31, wherein said vehicle comprises a disc brake, in particular a hydraulically actuatable disc brake.

33. Vehicle in accordance with claim 31, wherein the bicycle comprises an anti-lock braking system which interacts with a sensor unit, which comprises the sensor ring and in particular the sensor, and with the disc brake.
